(19) United States
(12) Patent Application Publication
(10) Pub. No.: US 2013/0330548 A1
(43) Pub. Date: Dec. 12, 2013

(54) PRESSURE-SENSITIVE ADHESIVE FILM OR SHEET, SURFACE PROTECTION FILM OR SHEET, AND USING METHOD FOR SURFACE PROTECTION OF ARTICLE

(71) Applicants: Masataka Aoyama, Chiba (JP); Koichiro Yamamoto, Chiba (JP); Yoshitaka Hironaka, Chiba (JP); Atsushi Morimoto, Chiba (JP); Chikara Ichinoseki, Chiba (JP)

(72) Inventors: Masataka Aoyama, Chiba (JP); Koichiro Yamamoto, Chiba (JP); Yoshitaka Hironaka, Chiba (JP); Atsushi Morimoto, Chiba (JP); Chikara Ichinoseki, Chiba (JP)

(73) Assignee: DU PONT-MITSUI POLYCHEMICALS CO., LTD., Tokyo (JP)

(21) Appl. No.: 14/002,009

(22) PCT Filed: Feb. 20, 2012
(86) PCT No.: PCT/JP2012/001091

§ 371 Date: Aug. 28, 2013

(30) Foreign Application Priority Data
Mar. 1, 2011 (JP) 2011-044235
Mar. 2, 2011 (JP) 2011-045575
Sep. 22, 2011 (JP) 2011-206712

(51) Int. Cl. C09J 123/08; C09J 7/02

(52) U.S. Cl. CPC C09J 123/08; C09J 7/0217
USPC 428/355 AC; 526/329; 525/228

(57) ABSTRACT

An adhesive film or sheet of the present invention includes an adhesive layer containing an ethylene-alkyl (meth)acrylate copolymer (A). The ethylene-alkyl (meth)acrylate copolymer (A) is a random binary copolymer of ethylene and alkyl(meth)acrylate, carbon atoms of an alkyl group of the alkyl(meth)acrylate are 2 or more, and a melting point T[° C.] measured based on JIS K7121-1987 and unit content X [mol %] of the alkyl (meth)acrylate satisfy the following Expression (1).

−3.0X+125≧T≧−3.0X+107 (1)
(Herein, the adhesive layer does not contain a high-crystalline ethylene-based or propylene-based copolymer having a melting temperature of equal to or higher than 115° C.)

### TECHNICAL FIELD

The present invention relates to a pressure-sensitive adhesive film or sheet, a surface protection film or sheet, and a method for using the pressure-sensitive adhesive film or sheet for the surface protection of an article.

### BACKGROUND ART

A pressure-sensitive adhesive film or sheet has been used as a surface protection film for protecting the surface of an article from attachment of dust, contamination, damage or the like.

In recent years, the pressure-sensitive adhesive film or sheet has been used as a surface protection film of a precision electric component such as a liquid crystal panel plate, a reflective plate, a retardation plate, a prism sheet, a light guide plate, a polarizing plate, a plasma display panel plate, an organic fluorescent thin film, or a transparent electrode or a flexible print substrate, a rigid print substrate, or the like which is a constituent element of a liquid crystal display apparatus, a plasma display apparatus, or an organic thin film EL apparatus.

The pressure-sensitive adhesive film or sheet is necessary to have strong adhesiveness between an adhesive layer and a base material layer, and suitable strength of adhesiveness between the adhesive layer and an adherend. This suitable strength of adhesiveness is a strength that does not allow natural self-peeling off or forced peeling-off due to small vibration or impact, and is a strength by which the adhesive layer can be smoothly peeled off from the surface of the adherend without remaining thereon, when performing peeling-off.

In addition, the adhesiveness between the adhesive layer and the adherend of the present invention is not for adhering the adhesive layer to the adherend by pressure-bonding under the heating conditions at equal to or higher than a melting point of the adhesive such as a hot-melt adhesive, but means interlayer peeling-off strength, when the adhesive layer is adhered to the adherend by pressure-bonding under the atmosphere at a temperature lower than the melting point.

The pressure-sensitive adhesive film or sheet which satisfies such required characteristics includes a film or sheet configured of an ethylene-vinyl acetate copolymer.

Patent Document 1 (Japanese Unexamined Patent Publication No. H08-170056) discloses a surface protection film in which an adhesive layer configured of an ethylene-vinyl acetate copolymer having content of vinyl acetate of equal to or more than 18% by mass and equal to or less than 26% by mass is formed on one surface of a base material layer configured of high-density polyethylene.

Patent Document 2 (Japanese Unexamined Patent Publication No. 2002-226814) discloses that a resin composition obtained by combining an amorphous propylene-based polymer to an ethylene-vinyl acetate copolymer is used as an adhesive layer.

Patent Document 3 (Japanese Unexamined Patent Publication No. 2007-204526) discloses that an ethylene-alkyl(meth)acrylate copolymer or an amorphous or low-crystalline α-olefin-based polymer is used as an adhesive layer.

Patent Document 4 (Pamphlet of International Publication WO. 2009/057624) discloses that a mixed resin obtained by combining a high-crystalline ethylene-based or propylene-based polymer or copolymer having a melting point of equal to or higher than 115° C. to an ethylene-unsaturated ester copolymer such as an ethylene-vinyl acetate copolymer is used as an adhesive layer.

### RELATED DOCUMENT

### Patent Document

[Patent Document 1] Japanese Unexamined Patent Publication No. H08-170056
[Patent Document 2] Japanese Unexamined Patent Publication No. 2002-226814
[Patent Document 3] Japanese Unexamined Patent Publication No. 2007-204526
[Patent Document 4] Pamphlet of International Publication WO. 2009/057624

### DISCLOSURE OF THE INVENTION

In recent years, in order to improve the productivity, a surface protection film or sheet is used to be attached to an adherend at a high speed. Due to such an increase in speed of the production rate, a surface protection film or a sheet is attached to a hot adherend which is not cooled yet.

The ethylene-vinyl acetate copolymer or the ethylene-alkyl(meth)acrylate copolymer has excellent initial adhesiveness with respect to the adherend. However, the adhesive thereof tends to have a temporal rise in adhesiveness of being stronger or weaker than the initial adhesiveness, and the adherend at a high temperature as described above, particularly has the more significant temporal rise thereof.

Some countermeasures have already been proposed for suppressing the temporal rise in adhesiveness of the ethylene-vinyl acetate copolymer or the ethylene-alkyl(meth)acrylate copolymer.

In Patent Document 2 (Japanese Unexamined Patent Publication No. 2002-226814), the temporal rise in adhesiveness at a high temperature is suppressed by combining a substantially amorphous propylene resin to the ethylene-vinyl acetate copolymer. Compared to conventional products, this mixed resin can suppress the temporal rise in adhesiveness and can exhibit the effects in some extent.

However, the improvement effect at a high temperature is not sufficient, and further improvement is required in this field.

In addition, in Patent Document 4 (Pamphlet of International Publication WO. 2009/057624), the temporal rise in adhesiveness at a high temperature is suppressed by combining a high-crystalline ethylene-based or propylene-based polymer or copolymer having a melting point of equal to or higher than 115° C. to an ethylene-unsaturated ester copolymer such as an ethylene-vinyl acetate copolymer or an ethylene-alkyl(meth)acrylate copolymer.

However, if the resin having high crystallinity described above is mixed therein, since the transparency of the film or sheet is degraded in some cases, it is not suitable in a case where high transparency is acquired. In addition, if the resin having high crystallinity described above is mixed therein, stiffness of the film or sheet is increased, curling easily occurs when using the film or sheet by feeding from a roll, and thus, handling of the film or sheet tends to be difficult. Further, when being used at a high temperature for a long period of time, the film or sheet is contracted and floating may occur. Accordingly, improvement thereof was required when being used under the severe conditions.

The present invention has been made to address the aforementioned problems and an object thereof is to provide a pressure-sensitive adhesive film or sheet in which initial adhesiveness is in a proper range and a temporal rise in adhesiveness is suppressed even at a high temperature, in a case of pressure-bonding of an adherend under conditions at a room temperature without positively heating the adhesive layer.

According to the present invention, there is provided a pressure-sensitive adhesive film or sheet including an adhesive layer containing an ethylene-alkyl(meth)acrylate copolymer (A) which is a random binary copolymer of ethylene and alkyl(meth)acrylate, in which carbon atoms of an alkyl group of the alkyl(meth)acrylate are 2 or more, and a melting point T[° C.] measured based on JIS K7121-1987 and unit content X [mol %] of the alkyl(meth)acrylate satisfy the following Expression (1).

−3.0X+125≧T≧−3.0X+107 (1)

Herein, the adhesive layer does not contain a high-crystalline ethylene-based or propylene-based copolymer having a melting temperature of equal to or higher than 115° C.

In addition, according to the present invention, there is provided a surface protection film or sheet including the pressure-sensitive adhesive film or sheet.

Further, according to the present invention, there is provided a using method of the pressure-sensitive adhesive film or sheet for surface protection of an article.

According to the present invention, it is possible to provide a pressure-sensitive adhesive film or sheet in which the initial adhesiveness is in a proper range and the temporal rise in adhesiveness is suppressed even at a high temperature.

### DESCRIPTION OF EMBODIMENTS

The object described above, other objects, characteristics, advantages become clear by preferred embodiments which will be described later.

Hereinafter, the embodiments of the present invention will be described.

A pressure-sensitive adhesive film or sheet of the embodiment includes an adhesive layer containing an ethylene-alkyl(meth)acrylate copolymer (A). The ethylene-alkyl(meth)acrylate copolymer (A) is a random binary copolymer of ethylene and alkyl(meth)acrylate, in which carbon atoms of an alkyl group of the alkyl(meth)acrylate are 2 or more, and a melting point T[° C.] measured based on JIS K7121-1987 and unit content X [mol %] of the alkyl (meth)acrylate satisfy the following Expression (1).

−3.0X+125≧T≧−3.0X+107 (1)

(Herein, the adhesive layer does not contain a high-crystalline ethylene-based or propylene-based copolymer having a melting temperature of equal to or higher than 115° C.)

(Adhesive Layer)

First, each component of the adhesive layer configuring the pressure-sensitive adhesive film or sheet of the embodiment will be described.

[Ethylene-Alkyl(Meth)Acrylate Copolymer (A)]

Ethylene-alkyl(meth)acrylate copolymer (hereinafter, called a copolymer (A)) which is an essential component of the adhesive layer of the embodiment is a random binary copolymer of ethylene and alkyl ester having 2 more carbon atoms, preferably 8 or less carbon atoms of acrylic acid or methacrylic acid.

Examples of alkyl acrylate or alkyl methacrylate include ethyl acrylate, isopropyl acrylate, n-propyl acrylate, isopropyl acrylate, isobutyl acrylate, n-butyl acrylate, acrylic acid-2-ethylhexyl, ethyl methacrylate, n-propyl methacrylate, isopropyl methacrylate, isobutyl methacrylate, n-butyl methacrylate, and the like.

Among them, alkyl(meth)acrylate having alkyl ester having equal to or more than 2 carbon atoms and equal to or less than 4 carbon atoms is preferable in a viewpoint of ease of acquisition, and balance of functions and cost.

Examples of such preferable copolymer (A) include ethylene-ethyl acrylate copolymer, ethylene-n-propyl acrylate copolymer, ethylene-isopropyl acrylate copolymer, ethylene-n-butyl acrylate copolymer, ethylene-isobutyl acrylate copolymer, ethylene-ethyl methacrylate copolymer, ethylene-n-propyl methacrylate copolymer, ethylene-isopropyl methacrylate copolymer, ethylene-n-butyl methacrylate copolymer, ethylene-isobutyl methacrylate copolymer, and the like.

In addition, the copolymer (A) of the embodiment is a random binary copolymer, and a component obtained by copolymerization of a plurality of alkyl(meth)acrylate and ethylene is also in the range of the random binary copolymer.

In addition, in the copolymer (A) of the embodiment, the melting point T [° C.] measured based on JIS K7121-1987 and the unit content X [mol %] alkyl(meth)acrylate satisfy the following Expression (1).

−3.0X+125≧T≧−3.0X+107 (1)

The copolymer (A) satisfying the Expression (1) has excellent heat resistance, compared to an ethylene-alkyl(meth)acrylate copolymer which does not satisfy the Expression (1). Accordingly, the adhesive layer of the embodiment can suppress the temporal rise in adhesiveness even at a high temperature by containing the copolymer (A) as an essential component.

The copolymer (A) satisfying the Expression (1) is not particularly limited, however, can be preferably acquired with a high pressure radical polymerization process by a tubular method.

For example, if total amount of ethylene gas and alkyl(meth)acrylate monomers and organic peroxide are introduced from an inlet of a tubular reactor, and polymerization is performed by setting an average reaction temperature in the reactor to be in a range of 150° C. to 250° C., the copolymer (A) satisfying the Expression (1) is acquired.

Since the reactivity of ethylene and alkyl(meth)acrylate is different, concentration of alkyl(meth)acrylate monomer in the ethylene gas changes at an inlet portion and an outlet portion in the tubular reactor. That is, the concentration of the alkyl(meth)acrylate monomer in the ethylene gas becomes high in the inlet portion and low in the outlet portion, and a copolymer having high content of alkyl(meth)acrylate and a copolymer having low content thereof are generated in a mixed manner. Among them, the copolymer having low content of alkyl(meth)acrylate has a higher melting point and heat resistance. Accordingly, when the average values of the content of alkyl(meth)acrylate of the copolymers are the same, since the copolymer (A) acquired by a tubular method has a higher melting point compared to the copolymer acquired by an autoclave method, it is possible to obtain the copolymer (A) satisfying the conditions of the Expression (1).

In the copolymer (A) of the embodiment, the unit content X of alkyl (meth)acrylate is preferably equal to or more than 0.5 mol % and equal to or less than 15 mol %, more preferably equal to or more than 0.5 mol % and equal to or less than 10 mol %, and even more preferably equal to or more than 1.5 mol % and equal to or less than 6 mol %. When using the copolymer (A) having X in the range described above, balance of a mechanical property, heat resistance, softness, and adhesiveness of the acquired adhesive layer is further improved.

The unit content X of alkyl(meth)acrylate is measured by infrared absorption spectrum (IR) ascriptive to alkyl(meth)acrylate. For example, in a case of ethyl acrylate (EA), the unit content X thereof is measured from absorbency of 860 cm⁻¹ ascriptive to EA. Herein, the standard curve is acquired by a correlation between the EA concentration acquired by nuclear magnetic resonance spectrum (NMR) and IR of absorbency of 860 cm⁻¹.

In addition, in the copolymer (A) of the embodiment, a melt flow rate (190° C., load of 2160 g) measured based on JIS K7210-1999 is preferably equal to or more than 1 g/10 minutes and equal to or less than 50 g/10 minutes, and more preferably equal to or more than 2 g/10 minutes and equal to or less than 30 g/10 minutes.

When using the copolymer (A) having the melt flow rate of equal to or more than the lower limit, smoothness of the surface of the acquired adhesive layer is excellent and the initial adhesiveness of the adhesive layer can be increased. In addition, at the time of aging, it is possible to suppress the copolymer (A) from floating on the surface of the adhesive layer. On the other hand, if the melt flow rate is equal to or less than the upper limit, the generation of low-molecular-component can be suppressed, and blocking of the acquired adhesive layer or contamination of the low-molecular-components on the protection base material can be suppressed.

[High-Crystalline Ethylene-Based or Propylene-Eased Polymer or Copolymer Having Melting Point of Equal to or Higher than 115° C.]

The adhesive layer of the embodiment does not contain a high-crystalline ethylene-based or propylene-based polymer or copolymer having a melting point of equal to or higher than 115° C. Examples of the polymer or the copolymer described above include high-density polyethylene, stereospecific polymerization polypropylene such as isotactic polypropylene, high-crystalline propylene-based copolymer, or the like.

If the polymer or copolymer described above is contained in the adhesive layer of the embodiment, the transparency of the adhesive film or sheet is degraded or the stiffness thereof is increased, in some cases.

Other than (A), it is preferable to not positively contain a polymer other than a tackifying resin (C) which will be described later in detail for maintaining such functions.

[Ethylene-Based Polymer (B)]

The adhesive layer of the embodiment may further contain an ethylene-based polymer (B) having a melting point of equal to or lower than 110° C. measured based on JIS K7121-1987. For example, the ethylene-based polymer (B) is at least one kind of ethylene-based polymer selected from ethylene-unsaturated ester copolymer (B-1) and low-density polyethylene (B-2).

By further containing the ethylene-based polymer (B) in the adhesive layer, it is possible to manufacture an adhesive film or sheet having further excellent balance of adhesiveness and transparency. In addition, it is possible to acquire a pressure-sensitive adhesive film or sheet in which the initial adhesiveness is excellent and the temporal rise in adhesiveness at a high temperature is further suppressed.

Examples of the ethylene-unsaturated ester copolymer (B-1) include an ethylene-vinyl ester copolymer or an ethylene-unsaturated carboxylic ester copolymer. In more detail, examples thereof include a binary copolymer of ethylene and vinyl ester such as vinyl acetate, vinyl propionate, a binary copolymer of ethylene and alkyl ester in which carbon atoms of unsaturated carboxylic acid such as maleic acid, maleic anhydride, fumaric acid, itaconic acid, or itaconic anhydride are about equal to or less than 20.

In addition, other than the binary copolymers described above, a multi-component copolymer obtained by copolymerization of ethylene and two or more kinds of the unsaturated ester may be used. Further, as long as the properties such as softness, elasticity, heat-sealing characteristics which is originally obtained in the ethylene-unsaturated ester copolymer are not substantially changed, small amounts of other polar monomers such as acrylic acid, methacrylic acid, maleic acid, itaconic acid, maleic anhydride, itaconic anhydride, or carbon monoxide may be further copolymerized.

Among them, as the ethylene-unsaturated ester copolymer (B-1) of the embodiment, the ethylene-vinyl ester copolymer, particularly the ethylene-vinyl acetate copolymer is preferable.

In addition, in the embodiment, among the ethylene-unsaturated ester copolymer (B-1), the copolymer which having the unit content of the unsaturated ester of equal to or more than 3% by mass and equal to or less than 46% by mass is preferable and the copolymer which having the unit content of equal to or more than 7% by mass and equal to or less than 33% by mass is particularly preferable. The ethylene-unsaturated ester copolymer (B-1) having the unit content of the unsaturated ester in the range described above has excellent compatibility with the copolymer (A), and the obtained adhesive layer can show excellent adhesiveness of the two components with less temperature dependency. In addition, the balance of the transparency, the mechanical property, the heat resistance, and the softness of the obtained adhesive layer is also excellent.

Further, in the ethylene-unsaturated ester copolymer (B-1) of the embodiment, the melt flow rate (190° C., load of 2160 g) measured based on JIS K7210-1999 is preferably equal to or more than 2 g/10 minutes and equal to or less than 50 g/10 minutes, and more preferably equal to or more than 3 g/10 minutes and equal to or less than 20 g/10 minutes. The adhesive layer containing the copolymer (B-1) having the melt flow rate in the range described above has further excellent balance of the adhesiveness, the workability, and the like.

The ethylene-unsaturated ester copolymer (B-1) described above can be obtained by radical copolymerization of ethylene and unsaturated ester at a high temperature and under high pressure, for example.

Examples of the low-density polyethylene (B-2) include high-pressure process low-density polyethylene and linear low-density polyethylene. If the polymer selected from them, and having a melting point of equal to or less than 110° C. is used, it is preferable since an adhesive film or sheet in which the adhesive rise is suppressed even at a high temperature can be provided.

The high-pressure process low-density polyethylene is obtained by polymerization under presence of a radical catalyst at high temperature and high pressure, and is manufactured by an autoclave method or a tubular method.

The linear low-density polyethylene is, for example, a copolymer of ethylene and α-olefin monomer having carbon atoms of equal to or more than 4 and equal to or less than 10 such as butene, 4-methyl-1-pentene, hexene-1, octene-1, and the copolymer which is manufactured by a ziegler catalyst and a metallocene catalyst can be acquired. The linear low-density polyethylene manufactured by the metallocene catalyst is particularly preferable since it shows excellent tendency in heat resistance.

In a case where the adhesive layer of the embodiment contains the ethylene-unsaturated ester copolymer (B-1) as the ethylene-based polymer (B), when the total amount of the adhesive layer is set to 100% by mass, the combined amount of (A) is preferably equal to or more than 2% by mass and equal to or less than 99% by mass and the combined amount of (B-1) is preferably equal to or more than 1% by mass and equal to or less than 98% by mass, the combined amount of (A) is more preferably equal to or more than 5% by mass and equal to or less than 98% by mass and the combined amount of (B-1) is preferably equal to or more than 2% by mass and equal to or less than 95% by mass, the combined amount of (A) is even more preferably equal to or more than 8% by mass and equal to or less than 98% by mass and the combined amount of (B-1) is preferably equal to or more than 2% by mass and equal to or less than 92% by mass, and the combined amount of (A) is particularly preferably equal to or more than 18% by mass and equal to or less than 70% by mass and the combined amount of (B-1) is preferably equal to or more than 30% by mass and equal to or less than 82% by mass.

If the combined amount of each component in the adhesive layer is in the ranges described above, it is possible to obtain a pressure-sensitive adhesive film or sheet having further excellent balance of the initial adhesiveness and the temperature dependency of adhesiveness. Other than (A) and (B-1), other polymers except for the tackifying resin (C) which will be described later are preferably not positively contained for maintaining such functions.

In addition, in a case where the adhesive layer of the embodiment contains the low-density polyethylene (B-2) as the ethylene-based polymer (B), when the total amount of the adhesive layer is set to 100% by mass, the combined amount of (A) is preferably equal to or more than 40% by mass and equal to or less than 99% by mass, the combined amount of (B-2) is preferably equal to or more than 1% by mass and equal to or less than 60% by mass, the combined amount of (A) is more preferably equal to or more than 40% by mass and equal to or less than 60% by mass, the combined amount of (B-2) is preferably equal to or more than 40% by mass and equal to or less than 60% by mass, and the combined amount of (A) is particularly preferably equal to or more than 45% by mass and equal to or less than 55% by mass, the combined amount of (B-2) is preferably equal to or more than 45% by mass and equal to or less than 55% by mass.

If the combined amount of each component in the adhesive layer is in the ranges described above, it is possible to obtain a pressure-sensitive adhesive film or sheet having further excellent balance of the initial adhesiveness and the temperature dependency of adhesiveness. Other than (A) and (B-2), other polymers except for the tackifying resin (C) which will be described later are preferably not positively contained for maintaining such functions.

[Tackifying Resin (C)]

The adhesive layer configuring the film or sheet of the embodiment may further contain a tackifying resin (hereinafter, called resin (C)) for improving the initial adhesiveness.

When the total amount of the adhesive layer is set to 100% by mass, the combined amount of the resin (C) is preferably more than 0% by mass and equal to or less than 30% by mass, more preferably more than 0% by mass and equal to or less than 20% by mass, and particularly preferably more than 0% by mass and equal to or less than 10% by mass.

If the combined amount of the tackifying resin (C) is equal to or less than 30% by mass, film formability is improved, and a surface blocking phenomenon can also be suppressed, and thus the handling as a film is excellent.

Examples of the resin (C) include petroleum-based resin such as a fatty based resin, aromatic based resin, fatty-aromatic copolymer based resin, or alicyclic based resin, a pinene resin, a coumarone-indene based resin, terpene based resin, a terpene phenol based resin, a polymerized rosin based resin, an (alkyl)phenol based resin, xylene based resin, and a hydrogenated resin thereof. In addition, such resins (C) may contain an olefin resin.

In the resin (C), a softening temperature measured based on JIS K2207-1996 ring-and-ball method is preferably equal to or higher than 90° C., more preferably equal to or higher than 115° C., and particularly preferably equal to or higher than 140° C. When using the resin (C) having the softening temperature of equal to or higher than the lower limit, it is possible to obtain a pressure-sensitive adhesive film or sheet in which the wide range of desired initial adhesiveness is obtained, and the temporal rise in adhesiveness at a high temperature is further suppressed. The upper limit of the softening temperature is not particularly limited, however, is preferably equal to or lower than 180° C. and more preferably equal to or lower than 170° C. in a viewpoint of general acquisition.

Examples of the resin (C) having the softening temperature of equal to or higher than 90° C. include ARKON P115 (softening temperature of 115° C.), ARKON P125 (softening temperature of 125° C.), ARKON P140 (softening temperature of 140° C.), PINECRYSTAL KE-604 (softening temperature of equal to or higher than 122° C. and equal to or lower than 134° C.), PINECRYSTAL KR-50M (softening temperature of equal to or higher than 145° C. and equal to or lower than 160° C.) which are product names manufactured by Arakawa Chemical Industries, Ltd. and YS Polyster T145 (softening temperature of 145° C.) and Clearon P150 (softening temperature of 150° C.) which are product names manufactured by Yasuhara Chemical Co., Ltd.

(Other Additives)

In addition, the adhesive layer of the embodiment may further contain additives which are generally used in a macromolecule field, such as an antioxidant, an ultraviolet absorbing agent, a light stabilizer, and an anti-blocking agent, to the extent of not degrading the characteristics of the adhesive layer.

(Manufacturing Method of Resin Composition)

The resin composition used for the formation of the adhesive layer of the embodiment is obtained by dry-blending or melt-blending of copolymer (A), and if necessary, the ethylene polymer (B), the resin (C), and the other additives, at the same time or sequentially, for example.

Various mixers such as a Hanschel mixer, a tumbler mixer, and the like can be used for the dry-blending.

In addition, in a case of performing the melt-blending, kneading devices such as single-screw extruder or twin-screw extruder, a Bunbury mixer, a roll, and a kneader can be used, and melt-kneading is performed at a temperature about equal to or higher than 140° C. and equal to or less than 230° C.

(Adhesive Film or Sheet)

Next, the manufacturing method of the pressure-sensitive adhesive film or sheet will be described.

The manufacturing method of the pressure-sensitive adhesive film or sheet of the embodiment is not particularly limited, however, the film or sheet can be obtained by forming the resin composition to a shape of a single-layered film or sheet, for example. In this case, the obtained single-layered film or sheet corresponds to the adhesive layer of the embodiment. In addition, the manufacturing method also can be obtained by forming the adhesive layer on at least one surface of a base material using the resin composition.

In general, the latter method, which is the method of forming the adhesive layer on at least one surface of the base material using the resin composition is used.

The base material is not particularly limited, however, a stretched or unstretched thermoplastic resin film or sheet formed by using one or more kinds of polyester, polyamide, polypropylene, blocked or random propylene based polymer having ethylene components as the copolymer component, low-density polyethylene, high-density polyethylene, or ethylene based polymer such as linear low-density or very low-density polyethylene, and polyolefin such as an ethylene-propylene copolymer; paper; metal foil; non-woven fabrics and the like, are used.

In the embodiment, among them, the base material containing polyolefin such as polyethylene or polypropylene is particularly preferable.

In a case of using the base material containing polyolefin, interlayer adhesiveness between the adhesive layer and the base material is excellent, and it is possible to obtain a film or sheet which is excellent in transparency.

In a case of using the thermoplastic resin film for the base material, for degradation prevention, the antioxidant, the ultraviolet absorbing agent, the light stabilizer such as a hindered amine light stabilizer, an anti-static agent, and other additives of fillers or pigments such as carbon black, calcium oxide, magnesium oxide, silica, zinc oxide, titanium oxide, or the like may be further combined into the thermoplastic resin which is the base material, if necessary.

The thickness of the base material is not particularly limited, however, is generally equal to or more than 1 μm and equal to or less than 500 μm, and preferably equal to or more than 10 μm and equal to or less than 200 μm.

In the method of forming the adhesive layer on the base material using the resin composition of the embodiment, for example, the forming thereof can be performed based on the conventional methods such as, a solution coating method of applying a solution of the resin composition or a hot-melt solution onto a base material, a method of transferring the formed adhesive layer after applying the solution onto the separator base material based on the coating method, a hot-melt coating method of performing extrusion coating of the resin composition on the base material, a method of performing coextrusion of the base material and the resin composition to a multi-layer of two layers or three or more layers, a method of performing extrusion laminating of the resin composition on the base material in a single-layered manner or a method of performing extrusion laminating of the resin composition and the adhesive layer in a double-layered manner, and a method of thermal laminating of the adhesive layer and a support base material forming material such as a film or laminated layer.

Among them, the method of performing coextrusion of the base material containing the thermoplastic resin and the resin composition to a multi-layer of two layers or three or more layers by an inflation method or T-die method is preferable.

In the embodiment, the thickness of the adhesive layer formed on the base material is appropriately determined according to adhesiveness or the like, however, in general, is preferably equal to or more than 1 μm and equal to or less than 250 μm, and more preferably equal to or more than 5 μm and equal to or less than 100 μm.

In addition, in a case of the single-layered film or sheet which does not have the base material, the thickness thereof is preferably equal to or more than 5 μm and equal to or less than 300 μm, and more preferably equal to or more than 10 μm and equal to or less than 200 μm.

The pressure-sensitive adhesive film or sheet of the embodiment is adhered onto the surface of the rigid adherend so that the adhesive layer face the surface thereof, only by pressure, without positively heating, and thus, the film or sheet is easily peeled off by hands if not necessary and no contaminant remains on the surface of the adherend. The pressure-sensitive adhesive film or sheet is used for surface protection of products such as a synthesis resin plate, a decorative sheet, a metal plate, and a coated steel plate, or for surface protection of window glass, and for surface protection at the time of baking-coating of a vehicle or at the time of solder immersion of a print substrate. Also, examples of the adherend include a liquid crystal panel plate, a reflective plate, a retardation plate, a prism sheet, a light guide plate, a polarizing plate, a plasma display panel plate, an organic fluorescent thin film, a transparent electrode, a flexible print substrate, a rigid print substrate, and the like which are constituent elements of a liquid crystal display apparatus, a plasma display apparatus, and an organic thin film EL apparatus. The pressure-sensitive adhesive film or sheet may be particularly suitably used as a surface protection film or a sheet for the adherends.

As another embodiment, a method of using the pressure-sensitive adhesive film or sheet for the surface protection of the product can be provided. The examples of the product which is an object of the surface protection have been described above.

Hereinabove, the embodiments of the present invention have been described, however, these are examples of the present invention, and other various configurations can be employed.

### EXAMPLES

Hereinafter, the embodiments will be described with Examples and Comparative Examples, however, the embodiments are not limited thereto.

In Examples and Comparative Examples, the following resins were used. In addition, the melt flow rate (MFR), the melting point, and the softening temperature of each resin were measured as described below.
MFR: JIS K7210-1999 (190° C., load of 2160 g)
Melting point: JIS K 7121-1987
Softening temperature: JIS K2207-1996 (ring-and-ball method)

(1) Copolymer (A)

(A1) Ethylene-n-butyl acrylate Copolymer
Content of n-butyl acrylate: 17% by mass (4.2 mol %)
MFR: 7 g/10 minutes
Melting point: 96° C. (note: the range of melting point measured by Expression (1) is 94° C. to 112° C.)
Manufacturing method: high-pressure radical polymerization by the tubular method

(A2) Ethylene-ethyl acrylate copolymer
Content of ethyl acrylate: 15% by mass (4.7 mol %)
MFR: 7 g/10 minutes
Melting point: 97° C. (note: the range of melting point measured by Expression (1) is 93° C. to 111° C.)
Manufacturing method: high-pressure radical polymerization by the tubular method

(2) Ethylene-based polymer (B)

1. Ethylene-unsaturated ester copolymer (B-1)

(B11) Ethylene-vinyl acetate copolymer
Content of ethylene: 90% by mass
Content of vinyl acetate: 10% by mass
MFR: 9 g/10 minutes
Melting point: 94° C.

(B12) Ethylene-vinyl acetate copolymer
Content of ethylene: 84% by mass
Content of vinyl acetate: 16% by mass
MFR: 2.7 g/10 minutes
Melting point: 89° C.

2. Low-density polyethylene (B-2)

(B21) Linear low-density polyethylene (SP0540 manufactured by Prime Polymer Co., Ltd.)
MFR: 3.8 g/10 minutes
Melting point: 98° C.

(3) Tackifying resin (C)

(C1) Hydrogenated petroleum resin (ARKON P140 manufactured by Arakawa Chemical Industries, Ltd.)
Softening temperature: 140° C.

(C2) Terpene hydrogenated resin (Clearon P150 manufactured by Yasuhara Chemical Co., Ltd.)
Softening temperature: 150° C.

(4) Other Polymers

(D1) Ethylene-ethyl acrylate copolymer
Content of ethyl acrylate: 19% by mass (6.2 mol %)
MFR: 5 g/10 minutes
Melting point: 84° C. (note: the range of melting point measured by Expression (1) is 88° C. to 106° C.)
Manufacturing method: high-pressure radical polymerization by the autoclave method

(D2) Ethylene-methyl acrylate copolymer
Content of methyl acrylate: 20% by mass (7.4 mol %)
MFR: 8 g/10 minutes
Melting point: 92° C. (note: the range of the melting point measured by Expression (1) is 85° C. to 103° C.)
Manufacturing method: high-pressure radical polymerization by the tubular method

In the experiments described below, polyethylene is used in a case of using the base material, however, polypropylene can also be used for the same effects. Herein, results obtained by using polyethylene as the representative example of the base material are shown.

### Example 1

Using a multi-layer extrusion cast molding apparatus (40 mmφ×3), extrusion molding was performed with low-density polyethylene (LDPE: Mirason 16SPO (product name) manufactured by Du Pont-Mitsui Polychemicals Co., Ltd.) as a base material, and ethylene-n-butyl acrylate copolymer (A1) as an adhesive layer, to obtain a test film (film configuration: LDPE/LDPE/adhesive layer=20/20/20 μm, total thickness of 60 μm).

### Example 2

Using the multi-layer extrusion cast molding apparatus (40 mmφ×3), extrusion molding was performed with low-density polyethylene (LDPE: Mirason 11P (product name) manufactured by Du Pont-Mitsui Polychemicals Co., Ltd.) as a base material, and a component which is obtained by adjusting a ratio of ethylene-n-butyl acrylate copolymer (A1) which was used in Example 1 and a tackifying resin (C1) to (A1)/(C1)=99/1 (% by mass), as an adhesive layer, to obtain a test film (film configuration: LDPE/LDPE/adhesive layer=20/20/20 μm, total thickness of 60 μm).

### Example 3

Using the multi-layer extrusion cast molding apparatus (40 mmφ×3), extrusion molding was performed with low-density polyethylene (LDPE: Mirason 16SPO (product name) manufactured by Du Pont-Mitsui Polychemicals Co., Ltd.) as a base material layer, and using C2 instead of the tackifying resin (C1) which was used in Example 2, to obtain a test film (film configuration: LDPE/LDPE/adhesive layer=20/20/20 μm, total thickness of 60 μm).

### Comparative Example 1

Using the multi-layer extrusion cast molding apparatus (40 mmφ×3), extrusion molding was performed with low-density polyethylene (LDPE: Mirason 16SPO (product name) manufactured by Du Pont-Mitsui Polychemicals Co., Ltd.) as a base material layer, and ethylene-vinyl acetate copolymer (B11) as an adhesive layer instead of ethylene-n-butyl acrylate copolymer (A1) which was used in Example 1, to obtain a test film (film configuration: LDPE/LDPE/adhesive layer=20/20/20 μm, total thickness of 60 μm).

### Comparative Example 2

Using the multi-layer extrusion cast molding apparatus (40 mmφ×3), extrusion molding was performed with low-density polyethylene (LDPE: Mirason 16SPO (product name) manufactured by Du Pont-Mitsui Polychemicals Co., Ltd.) as a base material layer, and linear low-density polyethylene (B21) manufactured with a metallocene catalyst as an adhesive layer instead of ethylene-n-butyl acrylate copolymer (A1) which was used in Example 1, to obtain a test film (film configuration: LDPE/LDPE/adhesive resin composition=20/20/20 μm, total thickness of 60 μm).

### Comparative Example 3

Using the multi-layer extrusion cast molding apparatus (40 mmφ×3), extrusion molding was performed with low-density polyethylene (LDPE: Mirason 11P (product name) manufactured by Du Pont-Mitsui Polychemicals Co., Ltd.) as a base material layer, and a component which is obtained by adjusting a ratio of ethylene-vinyl acetate copolymer (B11) and the tackifying resin (C1) to (B11)/(C1)=99/1 (% by mass), as an adhesive layer, instead of ethylene-n-butyl acrylate copolymer (A1) which was used in Example 1, to obtain a test film (film configuration: LDPE/LDPE/adhesive layer=20/20/20 μm, total thickness of 60 μm).

### Comparative Example 4

Using the multi-layer extrusion cast molding apparatus (40 mmφ×3), extrusion molding was performed with low-density polyethylene (LDPE: Mirason 11P (product name) manufactured by Du Pont-Mitsui Polychemicals Co., Ltd.) as a base material layer, and ethylene-ethyl acrylate copolymer (D1) as an adhesive layer, instead of ethylene-n-butyl acrylate copolymer (A1) which was used in Example 1, to obtain a test film (film configuration: LDPE/LDPE/adhesive layer=20/20/20 μm, total thickness of 60 μm).

### Comparative Example 5

Using the multi-layer extrusion cast molding apparatus (40 mmφ×3), extrusion molding was performed with low-density polyethylene (LDPE: Mirason 11P (product name) manufactured by Du Pont-Mitsui Polychemicals Co., Ltd.) as a base material layer, and ethylene-methyl acrylate copolymer (D2) as an adhesive layer, instead of ethylene-n-butyl acrylate copolymer (A1) which was used in Example 1, to obtain a test film (film configuration: LDPE/LDPE/adhesive layer=20/20/20 μm, total thickness of 60 μm).

### Example 4

Using the multi-layer extrusion cast molding apparatus (40 mmφ×3), extrusion molding was performed with low-density polyethylene (LDPE: Mirason 16SPO (product name) manufactured by Du Pont-Mitsui Polychemicals Co., Ltd.) as a base material, and using a component which is obtained by adjusting a ratio of ethylene-n-butyl acrylate copolymer (A1), ethylene-vinyl acetate copolymer (B11), and the tackifying resin (C1) to (A1)/(B11)/(C1)=(95/4.5/0.5) (% by mass), as an adhesive layer, to obtain a test film (film configuration: LDPE/LDPE/adhesive layer=20/20/20 μm, total thickness of 60 μm).

### Examples 5 to 13 and Comparative Examples 6 and 7

The process was performed in the same manner as Example 4, except for changing ratios of the resin composition of the adhesive layers to values shown in Table 1 and Table 2, respectively.

(Evaluation Criteria)

The following evaluation was performed for the obtained films. In addition, for the respective evaluation criteria, in order to reduce effects of the measurement irregularity, the measurement was performed five times and the average of the three measured values except the maximum value and the minimum value was used.

(1) Adhesive Property

Based on JIS Z0237-2009, the test film which is the adhesive composition and the acrylic plate were bonded to each other by repeating pressure bonding twice with a manual roller which is 2 kg, and the evaluation of the initial adhesiveness, temporal adhesiveness, and rise in adhesiveness (see below) is performed, by peel adhesion of 180 degrees at a peeling-off speed of 300 mm/min.

(1-1) Initial adhesiveness: measured after leaving the bonded sample plate at constant temperature and humidity (23° C.×50% RH (relative humidity)) for 30 minutes (conditions 0 in Tables 1 and 2).

(1-2) Temporal adhesiveness (adhesiveness after aging): the sample plate prepared for evaluation of the adhesive property was put into an oven and aging was performed for a predetermined time and at a predetermined temperature disclosed as the following.

Aging conditions 1: oven temperature 70° C.×3 hours

Aging conditions 2: oven temperature 80° C.×3 hours

Aging conditions 3: oven temperature 100° C.×3 hours

The sample taken out from the oven was left at a constant temperature and humidity (23° C.×50% RH), and then, the adhesiveness was measured after 30 minutes.

(1-3) Rise in Adhesiveness

Rising rate (%): [(temporal adhesiveness−initial adhesiveness)/initial adhesiveness]×100

This shows that as the numerical value is large, the temporal change of the adhesiveness is large and the initial adhesiveness is difficult to be maintained.

The above evaluation results were summarized in Tables 1 and 2.

In the films of Examples 1 to 3, the temporal rise in adhesiveness at a high temperature was suppressed. In the film of Example 2 used with the tackifying resin (C1), not only the improvement of the initial adhesiveness was obtained, but also, the temporal rise in adhesiveness at a high temperature was further suppressed.

In the films of Comparative Examples 1 and 3 using the ethylene-vinyl acetate copolymer (B11), the increase in adhesiveness after aging was great.

Also, with polyethylene (B21) of Comparative Example 2 having low density, the increase in adhesiveness after aging was great, and the increase in adhesiveness at a temperature equal to or higher than the melting point was particularly great.

As Comparative Example 4, even with the ethylene-alkyl (meth)acrylate copolymer in which the carbon atoms of the alkyl group of alkyl ester are 2 or more, if the conditions of Expression (1) was not satisfied, the increase in adhesiveness after aging was great.

On the other hand, as Comparative Example 5, even with the ethylene-acrylic acid ester copolymer (D2) which satisfies Expression (1), if the carbon atom of the alkyl group of alkyl ester was 1, the increase in adhesiveness after aging was great.

In the films of Examples 4 to 13, the temporal rise in adhesiveness at a high temperature was suppressed.

In addition, in the films not containing the component of copolymer (A) but containing the component of the ethylene-based polymer (B) in the adhesive layer as Comparative Example 1 or 6, the increase in adhesiveness after the aging was great, and the temporal rise in adhesiveness at a high temperature was not suppressed.

In addition, as Comparative Example 8, even with the ethylene-acrylic acid ester copolymer which satisfies Expression (1), if the carbon atom of the alkyl group of alkyl ester was 1, the increase of the adhesiveness after the aging was great.

TABLE 1

| | Ratio of resin | Conditions 0 | | Conditions 1 | | Conditions 2 | | Conditions 3 | |
|---|---|---|---|---|---|---|---|---|---|
| | composition | Adhesiveness | Rising | Adhesiveness | Rising | Adhesiveness | Rising | Adhesiveness | Rising |
| | (% by mass) | (g/25 mm) | rate (%) | (g/25 mm) | rate (%) | (g/25 mm) | rate (%) | (g/25 mm) | rate (%) |
| Ex. 1 | A1 = 100 | 4 | 100 | 9 | 125 | 11 | 175 | 15 | 275 |
| Ex. 2 | A1/C1 = 99/1 | 10 | 100 | 9 | −10 | 11 | 10 | 20 | 100 |
| Ex. 3 | A1/C2 = 99/1 | 7 | 100 | 11 | 57 | 13 | 86 | 27 | 286 |
| Ex. 4 | A1/B11/C1 = | 7 | 100 | 10 | 43 | 12 | 71 | 25 | 257 |
| | 95/4.5/0.5 | | | | | | | | |
| Ex. 5 | A1/B11 = 75/25 | 5 | 100 | 8 | 60 | 8 | 60 | 16 | 220 |
| Ex. 6 | A1/B11 = 50/50 | 5 | 100 | 7 | 40 | 7 | 40 | 11 | 120 |
| Ex. 7 | A1/B21 = 66/34 | 2 | 100 | 8 | 300 | — | — | 5 | 150 |
| Ex. 8 | A2/B11 = 50/50 | 3 | 100 | 11 | 267 | 10 | 233 | 15 | 400 |
| Ex. 9 | A1/B11 = 3/97 | 4.5 | 100 | 22 | 489 | 33 | 733 | 14 | 311 |
| Ex. 10 | A1/B11 = 5/95 | 4.6 | 100 | 17 | 370 | 15 | 326 | 15 | 326 |
| Ex. 11 | A1/B11 = 10/90 | 4.7 | 100 | 14 | 298 | 11 | 234 | 11 | 234 |
| Ex. 12 | A1/B11 = 20/80 | 4.9 | 100 | 8.8 | 180 | 8.6 | 176 | 9.2 | 188 |
| Ex. 13 | A1/B11 = 1/99 | 4.4 | 100 | 27 | 614 | — | — | 25 | 568 |

TABLE 2

| | Ratio of resin | Conditions 0 | | Conditions 1 | | Conditions 2 | | Conditions 3 | |
|---|---|---|---|---|---|---|---|---|---|
| | composition | Adhesiveness | Rising | Adhesiveness | Rising | Adhesiveness | Rising | Adhesiveness | Rising |
| | (% by mass) | (g/25 mm) | rate (%) | (g/25 mm) | rate (%) | (g/25 mm) | rate (%) | (g/25 mm) | rate (%) |
| Com. | B11 = 100 | 4.3 | 100 | 29 | 674 | 120 | 2791 | 42 | 977 |
| Ex. 1 | | | | | | | | | |
| Com. | B21 = 100 | 6 | 100 | 9 | 50 | 14 | 133 | 72 | 1100 |
| Ex. 2 | | | | | | | | | |
| Com. | B11/C1 = 99/1 | 5 | 100 | 46 | 820 | 107 | 2040 | 91 | 2175 |
| Ex. 3 | | | | | | | | | |
| Com. | D1 = 100 | 1 | 100 | 142 | 14100 | — | — | — | — |
| Ex. 4 | | | | | | | | | |
| Com. | D2 = 100 | 1 | 100 | 168 | 16700 | — | — | — | — |
| Ex. 5 | | | | | | | | | |
| Com. | B21/B12 = 66/34 | 2 | 100 | — | — | — | — | — | >200 Not |
| Ex. 6 | | | | | | | | | measurable |
| Com. | D2/B11 = 50/50 | 5 | 100 | >200 Not | — | >200 Not | — | >200 Not | — |
| Ex. 7 | | | | measurable | | measurable | | measurable | |

Priority is claimed on Japanese Patent Application No. 2011-44235, filed on Mar. 1, 2011, Japanese Patent Application No. 2011-45575, filed on Mar. 2, 2011, and Japanese Patent Application No. 2011-206712, filed on Sep. 22, 2011, the contents of which are incorporated herein by reference.

1. A pressure-sensitive adhesive film or sheet comprising an adhesive layer containing an ethylene-alkyl(meth)acrylate copolymer (A) which is a random binary copolymer of ethylene and alkyl(meth)acrylate, in which carbon atoms of an alkyl group of the alkyl(meth)acrylate are 2 or more, and a melting point T[° C.] measured based on JIS K7121-1987 and unit content X [mol %] of the alkyl(meth)acrylate satisfy the following Expression (1).
−3.0X+125≧T≧−3.0X+107 (1)
(Herein, the adhesive layer does not contain a high-crystalline ethylene-based or propylene-based copolymer having a melting temperature of equal to or higher than 115° C.)

2. The pressure-sensitive adhesive film or sheet according to claim 1,
wherein the adhesive layer further contains an ethylene-unsaturated ester copolymer (B-1) having a melting point measured based on JIS K7121-1987 of equal to or lower than 110° C., and
when the total amount of the adhesive layer is set as 100% by mass, the combined amount of the (A) is equal to or more than 2% by mass and equal to or less than 99% by mass, and the combined amount of the (B-1) is equal to or more than 1% by mass and equal to or less than 98% by mass.

3. The pressure-sensitive adhesive film or sheet according to claim 2,
wherein the (B-1) is an ethylene-vinyl ester copolymer or an ethylene-unsaturated carboxylic ester copolymer.

4. The pressure-sensitive adhesive film or sheet according to claim 1,
wherein the adhesive layer further contains low-density polyethylene (B-2) having a melting point measured based on JIS K7121-1987 of equal to or lower than 110° C., and
when the total amount of the adhesive layer is set to 100% by mass, the combined amount of the (A) is equal to or more than 40% by mass and equal to or less than 99% by mass, and the combined amount of the (B-2) is equal to or more than 1% by mass and equal to or less than 60% by mass.

5. The pressure-sensitive adhesive film or sheet according to claim 4, wherein the (B-2) is high-pressure process low-density polyethylene or is linear low-density polyethylene.

6. The pressure-sensitive adhesive film or sheet according to claim 1, wherein the carbon atoms of the alkyl group of the alkyl(meth)acrylate are equal to or more than 2 and equal to or less than 4.

7. The pressure-sensitive adhesive film or sheet according to claim 1, wherein a melt flow rate (190° C., load of 2160 g) of the (A) measured based on JIS K7210-1999 is equal to or more than 1 g/10 minutes and equal to or less than 50 g/10 minutes.

8. The pressure-sensitive adhesive film or sheet according to claim 1, wherein unit content X of the alkyl(meth)acrylate is equal to or more than 0.5 mol % and equal to or less than 15 mol %.

9. The pressure-sensitive adhesive film or sheet according to claim 1, wherein the adhesive layer further contains a tackifying resin (C).

10. The pressure-sensitive adhesive film or sheet according to claim 9, wherein the softening temperature of the (C) based on JIS K 2207-1996 ring-and-ball method is equal to or higher than 90° C.

11. The pressure-sensitive adhesive film or sheet according to claim 9, wherein, when the total amount of the adhesive layer is set to 100% by mass, the combined amount of the (C) is more than 0% by mass and equal to or less than 30% by mass.

12. The pressure-sensitive adhesive film or sheet according to claim 1, wherein the adhesive layer is formed at least on one surface of a base material.

13. The pressure-sensitive adhesive film or sheet according to claim 12, wherein the base material contains polyethylene or polypropylene.

14. A surface protection film or sheet comprising the pressure-sensitive adhesive film or sheet according to claim 1.

15. A using method of the pressure-sensitive adhesive film or sheet according to claim 1 for surface protection of an article.
